(19) United States
(12) Patent Application Publication
(10) Pub. No.: US 2010/0274735 A1
(43) Pub. Date: Oct. 28, 2010

(54) Investment Portfolio Partitioning for Improved Returns

(76) Inventor: Martin Bud, London (GB)

Correspondence Address: HARRIET M. STRIMPEL, D. Phil., New England Biolabs, Inc., 240 COUNTY ROAD, IPSWICH, MA, 01938-2723, US

(21) Appl. No.: 12/767,362

(22) Filed: Apr. 26, 2010

Related U.S. Application Data
(60) Provisional application No. 61/172,423, filed on Apr. 24, 2009.

(51) Int. Cl. G06Q 40/00

(52) U.S. Cl. 705/36 R

(57) ABSTRACT

Described herein is a two-step elimination procedure of companies in a diversified portfolio that yields a selection of companies that overall has reduced risk and improved returns compared to the diversified portfolio.

### CROSS REFERENCE

This application claims priority from U.S. Provisional Application No. 61/172,423 filed Apr. 24, 2009, herein incorporated by reference.

Described herein is a two-step elimination procedure of companies in a diversified portfolio that yields a selection of companies that overall has reduced risk and improved returns compared to the diversified portfolio.

It is said that the annual return of a diversified portfolio of two dozen companies from the Financial Times index (FT350) will mirror a stock market index return.

Diversification should make allowance for fluctuating attractions of market sectors, of company betas, and of the specific risks of a company's shares moving independently of the market.

Allowance for such fluctuations would provide satisfactory year-to-year index-matching returns of a near-unchanged portfolio, with provision merely for replacement of company dropouts due to mergers, etc.

Such allowance also implies likely year-to-year changes of portfolio inter-company performances, for example, of the best, middle and lowest performing group of companies as measured by return rates.

The following is a method that aims to select annually a minority of companies from the diversified portfolio by a two-step elimination procedure. A first elimination procedure (disqualification) is applied to remove those companies in the diversified portfolio that are exposed to excess risk. The remaining companies form the benchmark portfolio. The second elimination procedure results in a refined portfolio that contains selected companies that yields overall abnormal and actual returns in the following 12 months that are superior to those of the benchmark portfolio. Returns refer to investments made 6 months after the end of companies' common financial years when annual accounts have been published and a new half-year has elapsed.

The procedures and selection rules described here are viewed as applicable to companies, excluding banks, with common financial years, listed in the FT350, or other leading indices.

The procedures link balance sheet shareholders funds to their capitalisations, and inter-year capitalisation changes to asset changes that are in turn related to shareholders funds changes. Corresponding categories defined below are graded numerically in rankings and rank differences that are tolerance-bounded for investment selection.

### Procedural Framework

Financial year-end balance sheets (BS) provide details of assets (TA) and of shareholders funds (SF) [SF=net assets−(minorities+preference shares)]. Capitalisation (C) is calculated at a date 6 months after the BS date. That date is deemed to be the investment date and the start of a 12 month returns period.

Investment Return=the sum of capitalisation change+corresponding period's dividends during the 12-month interval between preceding (balance sheet date+6 months) and latest annual (balance sheet date+6 months).

Financial year ratios are calculated for BS and capitalisation values.

### Definitions

[F]=shareholders funds [SF]−attributable proportion of (inventories+current year intangible assets increase)

Attributable proportion=SF/(SF+minorities+preferred stock)

[A]=total assets (TA)−sum of (inventories+current year intangible assets increase)

### Categories

1) [F/A]=worth (w)
2) [Capitalisation (6 months post BS)]/[F]=[C/F]=esteem (e)
3) [Capitalisation]/[Assets]=[C/A]

### Growth Ratios of Categories And Constituent Companies

1) [F] this year/[F] preceding year (on BS dates)=gF
2) [A] this year/[A] preceding year (on BS dates)=gA
3) [C] this year/[C] preceding year (BS dates+6 months)=gC

Sources of unliquidated benefits are looked upon with distrust, particularly inventories and their included overheads. When they are not material, their exclusion makes little difference. These considerations also apply to augmentations of intangible assets. When paid for by issue of shares at a premium credited to reserves, the premium swells shareholders funds and their ratio to total assets. When a company's [F] is negative, the company is deemed to lack collateral borrowing capacity, to be of junk status not suitable for risk-averse investors, and is eliminated in the first exclusion step to create the benchmark portfolio.

### Second Step of Exclusion

### Rankings

Attempts to impose a common classification structure on the categories encounter diversities of origin, for example, balance sheet data that emanate from the company as against capitalisations that emanate from the market. Circumstances militate against expectation of symmetrical distributions within more than a limited portion of category populations. The method outlined below for ranking benchmark companies' populations within balance sheet or growth ratios permits simple arithmetic difference statements within and between categories.

Within every benchmark portfolio, companies are counted and arrayed in descending order using any parameter of size for example the balance sheet ratio or growth ratio, there will be a median count number “j” of value “m”, and a largest symmetrical “middle class” range of mean value “v”=>“m” <the preceding value at “j+1”. Subtraction of the middle class mean “v” from the value of every portfolio member diminishes the value of each, leaving the middle class with a zero-mean (0-mean). Division of every diminished population member by the standard deviation of the 0-mean middle class range leaves the middle class range with a unit standard deviation and every selected company in the portfolio distinguished by a deviation which is a multiple of the unity standard deviation.

Let those standard deviation multiples be regarded as “protocol” rankings in bands of ½ standard deviations. Let ranks 0-4 denote 5 successive negative ½ standard deviations up to 0-mean, and let 5-9 denote 5 successive positive standard deviations up to +2½. Ranks 0-9 are also likely to embrace the majority of near-symmetrical middle-class ranges.

Category rankings and differences between rankings serve to express their measures and tolerance bounds of differences. Subdivision of the ½ standard deviation grades could permit tightening of rank difference tolerances.

### Specific Risks (SpR)

SpR=A share's tendency to move independently of the market. London Business School Risk Management tables provide SpR scores for London Stock Market Companies at investment dates.

SpR outcomes are not necessarily adverse. Our system allows for “toning” of specific risks. On division of the square of a company's SpR by the product of (c^{x})×(w), a quotient<Qᵢ is viewed as acceptable “worth fallback”, while SpR²/c^{x-1}×gF>Q₂ falls outside selectable shareholders funds “achievement” acceptability. [c=constant]

Betas at investment date may be selection-restricted, e.g. to ceiling<1.31.

Embodiments of the invention may be performed by means of a computer with a memory to store the instructions and a processor that is configured to execute the instructions so as to perform the methods and calculations described herein.

### EXAMPLE

Table 1 lists 18 years annual returns out of a fairly stable menu of shares in about 25 non-bank companies from within the major 350 companies quoted on the London stock market. Annual returns are as derived from £10,000 invested and deemed allocated in equal amounts to each of the companies in the benchmark or invested in equal share to each selected company from the benchmark.

The companies have common financial years ending 31^{st} December. Holdings in benchmark portfolios and in selected companies are deemed acquired on 30^{th} June following the end of companies' financial years and realised 12 months thereafter. Investments of new selections of companies also made or deemed to be made at the time.

The application of the two-step exclusion procedure described above resulted in improved returns of the selected companies compared with returns from the benchmark menu in 16 years out of 18 years (as against the target of 15 years out of 18 years). Transaction costs have been ignored.

There are established techniques of “Fundamental Analysis” (ref. Google & Wikipedia) widely employed by respected Chartered Financial Analysts. The outcomes of their appraisals of relative companies strengths and weaknesses are in proprietary relative weightings and simulation packages. Their focus on earnings expectations tends to be less oriented on relative returns within a diversified portfolio.

### Data Sources

Company Balance Sheets . . . Hemscott.net
Capitalisations, Specific Risks, Betas, Returns
Risk Management Service tables . . . London Business School

TABLE 1
Non-Financial Companies
$10,000 Investment, Portfolio and Selection 12-mos Returns
Analysed as “Abnormal” & “Normal”
Italics denote Selections shortfall against Portfolio

| | | index | index | | | | | | | | | |
|---|---|---|---|---|---|---|---|---|---|---|---|---|
| A/cs | Returns | Global | FT 250 | | | | | | | | | |
| y/e | y/e | Equity | AR | Actual | | | | Portfolio | | | | Selected |
| December | June | Returns | Returns | Returns | no. | AR | Norm | Returns | no. | AR | Norm | Returns |
| 89 | 91 | 1,700 | 0 | 400 | 23 | −304 | 270 | −35 | 6 | 667 | 450 | 1,117 |
| 90 | 92 | −200 | 0 | 1,000 | 24 | 775 | 988 | 1,763 | 4 | 8,525 | 1,000 | 9.525 |
| 91 | 93 | 2,100 | 900 | 3,200 | 24 | −92 | 2,408 | 2,317 | 3 | 2,967 | 2,633 | 5,600 |
| 92 | 94 | 100 | 300 | 900 | 24 | 508 | 608 | 1,117 | 7 | 600 | 629 | 1,229 |
| 93 | 95 | 2,000 | −700 | 1,000 | 24 | −24 | 1,592 | 1,568 | 4 | −167 | 1,433 | 1,267 |
| 94 | 96 | 1,800 | 700 | 2,700 | 21 | 1,014 | 1,862 | 2,876 | 6 | 1,467 | 1,933 | 3,400 |
| mean | | 1,250 | 200 | 1,533 | 23 | 313 | 1,288 | 1,601 | 5 | 2,343 | 1,346 | 3,689 |
| | | 0.78 | 0.64 | 0.96 | 1.00 | 1.00 | 1.00 | 1.00 | 0.21 | 7.49 | 1.05 | 2.30 |
| stdev/mean | | 0.82 | 2.86 | 0.74 | 0.05 | 1.69 | 0.63 | 0.63 | 0.31 | 1.37 | 0.62 | 0.91 |
| 95 | 97 | 2,200 | −1,754 | 581 | 23 | 426 | 2,213 | 2,639 | 4 | 1,750 | 2,050 | 3,800 |
| 96 | 98 | 2,100 | −84 | 2,736 | 22 | 564 | 2,823 | 3,386 | 7 | 1,200 | 2,700 | 3,900 |
| 97 | 99 | 3,000 | −73 | 961 | 22 | 1,023 | 1,041 | 2,064 | 8 | 1,775 | 1,013 | 2,788 |
| 98 | 00 | −1,000 | 1,017 | 1,529 | 24 | 763 | 508 | 1,271 | 7 | 3,300 | 500 | 3,800 |
| 99 | 01 | −1,200 | 424 | −202 | 24 | 321 | −683 | −363 | 4 | 2,300 | −375 | 1,925 |
| 00 | 02 | −2,200 | 452 | −1,031 | 24 | 129 | −1,471 | −1,342 | 3 | 1,067 | −1,533 | −467 |
| mean | | 483 | −3 | 762 | 23 | 537 | 738 | 1,276 | 6 | 1,899 | 726 | 2,624 |
| | | 0.38 | −0.01 | 0.60 | 1.00 | 1.00 | 1.00 | 1.00 | 0.24 | 3.53 | 0.98 | 2.06 |
| stdev/mean | | 4.54 | −316 | 1.73 | 0.04 | 0.60 | 2.23 | 1.42 | 0.38 | 0.43 | 2.14 | 0.65 |
| 01 | 03 | 2,600 | 417 | −644 | 24 | −333 | −1,033 | −1,367 | 4 | −1,450 | −1,125 | −2,575 |
| 02 | 04 | 1,100 | 1,238 | 2,997 | 28 | 1,489 | 1,914 | 3.404 | 7 | 3,000 | 1,529 | 4,529 |
| 03 | 05 | 1,600 | 56 | 2,075 | 27 | −207 | 1,867 | 1,659 | 8 | 363 | 1,663 | 2,025 |
| 04 | 06 | 1,700 | 916 | 3,112 | 0 | 577 | 2,065 | 2,642 | 4 | 4,025 | 2,175 | 6,200 |
| 05 | 07 | n.a. | 594 | 2,523 | 25 | 610 | 1,885 | 2,495 | 6 | 1,016 | 1,666 | 2,683 |
| 06 | 08 | n.a. | −344 | −1,840 | 25 | 644 | −1,328 | −692 | 2 | 5,250 | −1,700 | 3,500 |

| | | | | | | | | | | | |
|---|---|---|---|---|---|---|---|---|---|---|---|
| mean | 1,750 | 480 | 1,371 | 22 | 463 | 895 | 1,357 | 5 | 2,034 | 701 | 2,727 |
| | 1.29 | 1.04 | 1.01 | 1.00 | 1.00 | 1.00 | 1.00 | 0.24 | 4.39 | 0.78 | 2.01 |
| stdev/mean | 0.36 | 1.19 | 1.59 | 0.49 | 1.43 | 1.80 | 1.43 | 0.43 | 1.23 | 2.37 | 1.09 |

What is claimed is:

1. A methods of partitioning a given menu of a plurality of diversified non-bank companies with common financial year ends, by:
(a) eliminating from a diversified portfolio those companies deemed to lack collaterally secured borrowing capacity, the remaining companies constituting a benchmark portfolio characterized by data categories for each company;
(b) arraying for each category, its benchmark population in serially numbered descending order of respective size, and identifying the median-numbered member of each category population, and the size attributed to that member;
(c) identifying the largest consecutive middle class range of companies in each of the benchmark category populations of which the mean size equals or exceeds the size of the median population member, the mean size being smaller than the size of its serially preceding larger population member;
(d) subtracting the mean value from the size of each member of the population, leaving the “middle class” range with zero mean;
(e) dividing each member of the of the reduced-size population by the standard deviation of the zero-mean “middle-class” range, obtaining a “middle class” standard deviation=1, and a multiple of unity for every other member of the population;
(f) attributing progressively-numbered rankings for the standard deviation multiple of unity of companies into range steps;
(g) attributing selection tolerance bounds to rank the differences between the data categories that characterize each company;
(h) precluding investment selection when a company's Specific Risk (SpR) exceeds either of two handicap quotients, one of which is calculated by dividing SpR² by the product of its F/A ratio, and the other of which is calculated by dividing SpR² by the product of its gF ratio and a constant; and
(i) determining according to steps (a)-(f), company selections for investment 6 months after the end of the preceding financial year in expectation of their superior 12 months abnormal and actual returns over corresponding returns of the benchmark portfolio.

2. A method according to claim 1, where the plurality of diversified companies is at least 24 companies.

3. A method according to claim 1, wherein the progressively numbered rankings in (f) are selected to be ½ standard deviations.

4. A computer processor capable of performing instructions according to the method of claims 1 through 3 and stored in a computer memory to select from an equity investment portfolio a subset of constituent portfolio companies expected to yield higher rates of abnormal and actual return in their forthcoming financial year than the portfolio as a whole.
